(19) United States
(12) Patent Application Publication
(10) Pub. No.: US 2021/0201888 A1
(43) Pub. Date: Jul. 1, 2021

(54) Computer-Implemented Phoneme-Grapheme Matching

(71) Applicant: Oxford Learning Solutions Limited, Oxford (GB)

(72) Inventor: Matthew Bradshaw, Oxford (GB)

(73) Assignee: Oxford Learning Solutions Limited, Oxford (GB)

(21) Appl. No.: 16/071,221

(22) PCT Filed: Jan. 20, 2017
(86) PCT No.: PCT/GB2017/050143

§ 371 Date: Jul. 19, 2018

(30) Foreign Application Priority Data
Jan. 22, 2016 (GB) 1601205.6

(51) Int. Cl. G10L 15/02

(52) U.S. Cl. CPC G10L 15/02; G10L 2015/025

(57) ABSTRACT

A computer-implemented method involves matching a predetermined sequence of phonemes with a predetermined sequence of graphemes representing one or more words. For each of the phonemes, there is accessed a set of possibly matching graphemes with an associated probability of matching; the probability may be derived from a set of previously matched phonemes and graphemes. For each phoneme, each of the possibly matching graphemes is compared with a sequence of characters in the one or more words, and a score is assigned to each possibly matching grapheme within the sequence of characters. Where there are a plurality of sequences of possibly matching graphemes, a threshold score may be applied, and the sequences may be ranked according to score.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent Office patent file or records, but otherwise reserves all copyright whatsoever.

### TECHNICAL FIELD

The present invention relates to a computer-implemented method of matching a sequence of phonemes with a sequence of graphemes, and to apparatus and a computer program product for carrying out the method.

### BACKGROUND

In computer-implemented speech synthesis, it is known to generate an output sequence of phonemes (e.g. speech elements) from an input sequence of characters representing one or more words. This may involve looking up each word in a database and obtaining a sequence of phonemes corresponding to that word. In cases where the word is not present in the database, the speech synthesizer may apply a set of rules to group characters of the text into graphemes, each of which corresponds to a single phoneme or group of phonemes.

Typically, a speech synthesis dictionary represents a sequence of phonemes correspond to a whole word; the correspondence between individual phonemes or phoneme groups and graphemes is not represented, because this is not required for speech synthesis. However, in some cases it is desirable to identify the relationship between individual phonemes or phoneme groups and graphemes, for example as a training input to a machine learning algorithm for a speech synthesizer or speech recognizer, in order to derive rules for handling words that are not in the dictionary. In English, and many other languages, many words have more letters than phonemes. In addition, in any language with a non-phonemic orthography, the relationship between graphemes and phonemes is inconsistent.

### OVERVIEW

According to one aspect of the present invention, there is provided a computer-implemented method of matching a predetermined sequence of phonemes with a predetermined sequence of graphemes representing one or more words. For each of the phonemes, there is accessed a set of possibly matching graphemes. There may be accessed an associated probability of matching; the probability may be derived from a set of previously matched phonemes and graphemes. For each phoneme for which there are a plurality of potentially matching graphemes, each of the possibly matching graphemes is compared with a sequence of characters in the one or more words, and a score is assigned to each possibly matching grapheme within the sequence of characters. Where there are a plurality of sequences of possibly matching graphemes, sequences may be selected according to their overall score. The selected sequences may be ranked by score.

Other aspects of the present invention include a computer system arranged to carry out the method, and a computer program product including program code means arranged to carry out the method when executed by a suitably arranged computer.

### BRIEF DESCRIPTION OF THE DRAWINGS

Specific embodiments of the present invention will now be described with reference to the accompanying drawings, in which:

FIG. 1 is a diagram of a system architecture in an embodiment of the invention;

FIG. 2 is a flowchart of a method in an embodiment of the invention; and

FIG. 3 is a diagram of a computer system for use in the embodiment

### DESCRIPTION OF EXAMPLE EMBODIMENTS

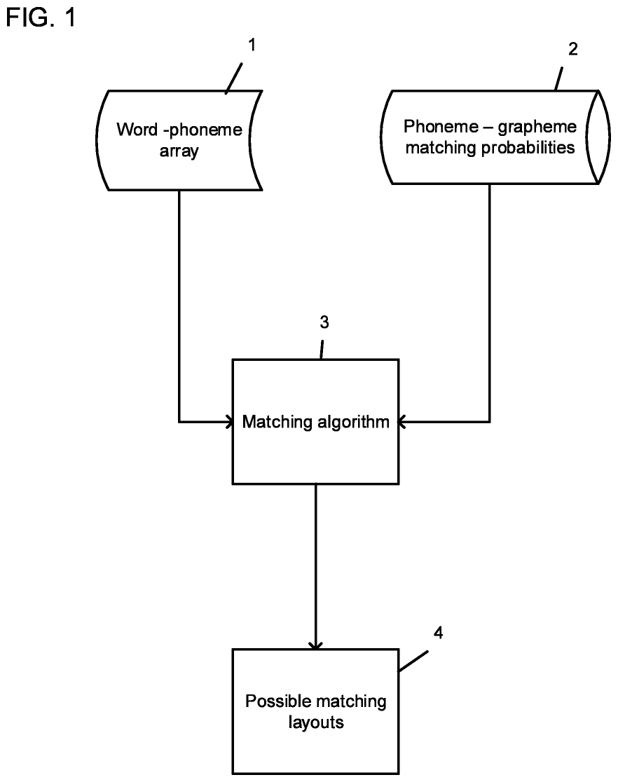

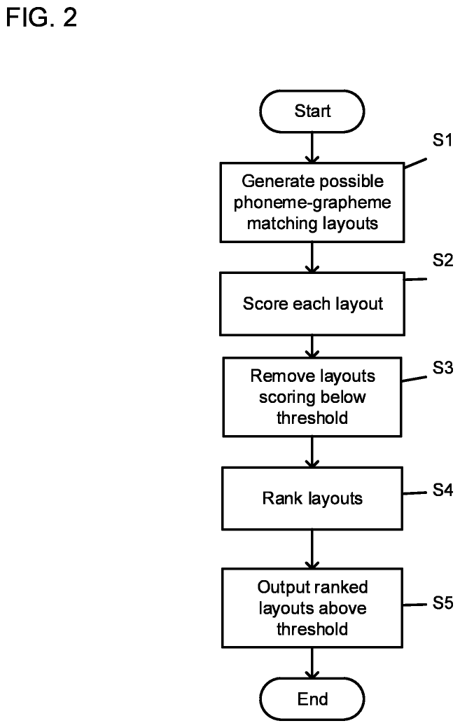

A method according to a specific embodiment of the invention will now be described with reference to FIGS. 1 and 2 of the drawings, and the Appendix which lists a sample PHP script comprising a computer program for performing the method according to this embodiment.

There is provided as input a word-phoneme array 1 containing a set of words and their known corresponding phoneme sequence, for example as in Table 1 below.

TABLE 1

| Word | Phoneme Sequence |
|---|---|
| Test | t e1 s t |
| Speaker | s p e2 k e3 |
| Eight | a2 t |
| Freight | f r a2 t |
| Rhythm | r i1 th m |
| Nation | n a2 sh u3 n |
| Pseudonym | s u2 d u1 n i1 m |

As can be seen from Table 1, to avoid using non-standard characters, phonemes are represented in this embodiment by one or more letters representing the approximate sound, followed by a numeral representing a predetermined variant of that sound. However, any suitable phoneme representation may be used, including for example characters of a phonetic alphabet such as the International Phonetic Alphabet.

There is also provided as input a phoneme matching database 2 containing phonemes and possible matching graphemes, together with a probability indication (e.g. score or weighting) for that match. For example, the letter “a” with a short “a” sound (such as in “cat”) would receive a low score, representing a high probability, while the letter “d” with a “z” sound is very unlikely and would therefore receive a higher score. The graphemes may comprise more than one letter; for example, in the words ‘Eight’ and ‘Freight’, the grapheme “eigh” corresponds to the phoneme “a2”. The phoneme matching database 2 also contains other possible grapheme matches for the phoneme “a2”, such as “ay” and “ai”, each with their corresponding probability indications.

The matching algorithm 3 is applied separately to each word in the word-phoneme array 1. The operation of the matching algorithm 3 on an individual word is shown in FIG. 2. At step S1, the algorithm 3 generates one or more possible ‘layouts’ each consisting of a sequence of graphemes within the word corresponding to the given sequence of phonemes. An example showing different possible layouts for the word ‘Pseudonym’ is shown in Table 2 below.

TABLE 2

Layout

| Phonemes | 1 | 2 | 3 |
|---|---|---|---|
| [silent] | p | p | |
| s | s | se | ps |
| u2 | eu | u | eu |
| d | d | d | d |
| u1 | o | o | o |
| n | n | n | n |
| i1 | y | y | y |
| m | m | m | m |

The layouts may be determined by processing letters in sequence from the start of the word (or in reverse from the end of the word), identifying possible graphemes matching the first given phoneme in the sequence of phonemes, setting up a layout for each of possible graphemes and then proceeding to the next unmatched letters of the word with the next phoneme. Alternatively, possible layouts may be determined by first identifying any phonemes for which there is only one possible matching grapheme in the word, and then processing the remaining letters of the word by identifying possible graphemes matching the remaining phonemes.

If there are multiple possible matching graphemes for the next phoneme for that layout, the layout may be divided into separate layouts corresponding to each of the possible matches.

If the database 2 does not contain any possible matches between a candidate phoneme and possible graphemes in the unmatched letters in the word, the algorithm 3 may identify a possible match based on the type of phoneme and the types of unmatched letters, for example as shown in Table 3 below.

TABLE 3

| Phoneme Type | Grapheme type | Score |
|---|---|---|
| Vowel | Vowel | 5 |
| Consonant | Consonant | 6 |
| Consonant | Mixed | 7 |
| Vowel | Mixed | 10 |
| Vowel | Consonant | 15 |
| Consonant | Vowel | 25 |

In this table, a lower score indicates a higher probability of a correct match. A ‘mixed’ grapheme contains a mixture of vowel and consonant letters. A vowel may be defined as a member of the set (a, e, i, o, u), and a vowel phoneme may be defined as a phoneme containing at least one vowel.

Alternatively, if there are no matches in the database 2 between the unmatched letters and the candidate phoneme for a particular layout, that layout may be discarded.

At step S2, an overall score is attributed to each layout, based on the individual probability scores for the individual phoneme-grapheme matches in the layout. The individual probability scores may be added, multiplied or combined together in some other way such that the overall score of the layout is representative of the combined probability of the phoneme-grapheme matches in the layout.

At this point, the layout having the highest overall probability may be selected for output by the algorithm. However, in some embodiments it may be desired to output the most probable layouts, above a threshold probability. For example, this may allow a human operator to correct the output if the correct layout is not given the highest probability by the matching algorithm 3. This correction may be used to modify the phoneme-grapheme matching database 2, for example by identifying the differences in phoneme-grapheme matching between the correct layout and the layouts that were ranked higher than the correct layout by the matching algorithm, and modifying the probability scores for those different matchings.

At step S3, a threshold score is determined, above which layouts may be discarded as being improbable. The threshold score may be determined as a function of the best score and/or of the number of phonemes in the corresponding word, for example:

(Threshold score)=(Best Score)+C*(Number of Phonemes in Word)

Layouts scoring below the threshold score may be flagged as possible alternative layouts. These layouts may be sorted by score at step S4, and output as a ranked list of possible layouts 4 at step S5.

The ranked list of possible layouts may be provided as input to a further computer-implemented process, such as a machine learning algorithm for a speech synthesizer, or a visual indicator for a speech synthesiser that indicates the grapheme corresponding to a phoneme spoken by the speech synthesizer.

In the case where only one possible layout is found for a given word, the scoring and ranking steps may be omitted for that word, and the possible layout is output.

The layout or layouts may be output in any form suitable for indicating the correspondence between graphemes and phonemes in the given word; for example, for the given word ‘pseudonym’ the output could for example be a string of any one of the following forms, depending on the format required:

Explicit pairs: (s, ps), (u2, eu), (d,d), (u1, o), (n, n), (i1, y), (m, m)

Graphemes only (as sequence of phonemes is known): ps, eu, d, o, n, y, m

Grapheme Boundary positions (as word is also known): 2, 4, 5, 6, 7, 8

Computer System

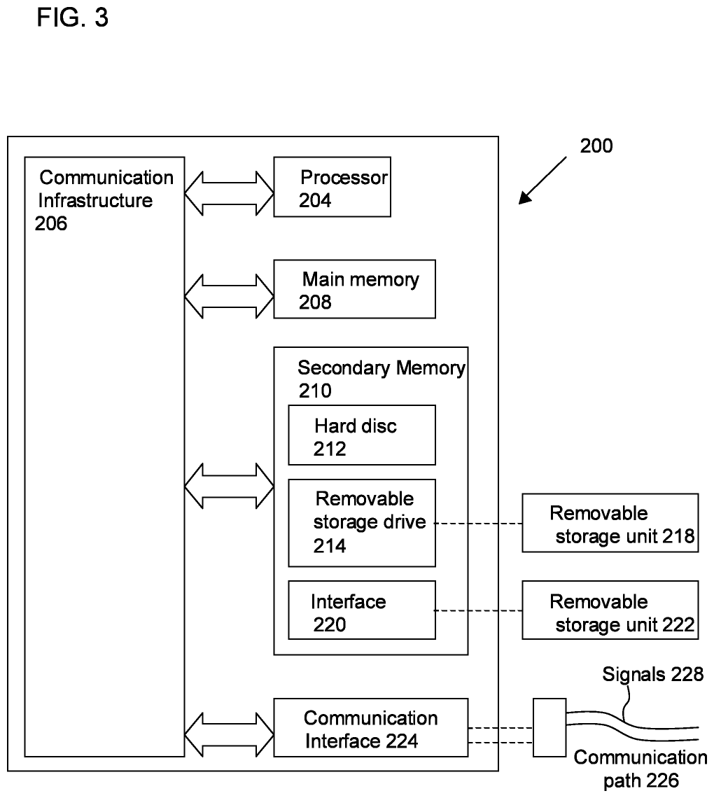

The method described herein, such as the matching algorithm 3, may be implemented by computer systems such as computer system 200 as shown in FIG. 3. Embodiments of the present invention may be implemented as programmable code for execution by such computer systems 200. After reading this description, it will become apparent to a person skilled in the art how to implement the invention using other computer systems and/or computer architectures.

Computer system 200 includes one or more processors, such as processor 204. Processor 204 may be any type of processor, including but not limited to a special purpose or a general-purpose digital signal processor. Processor 204 is connected to a communication infrastructure 206 (for example, a bus or network). Various software implementations are described in terms of this exemplary computer system. After reading this description, it will become apparent to a person skilled in the art how to implement the invention using other computer systems and/or computer architectures.

Computer system 200 also includes a main memory 208, preferably random access memory (RAM), and may also include a secondary memory 610. Secondary memory 210 may include, for example, a hard disk drive 212 and/or a removable storage drive 214, representing a floppy disk drive, a magnetic tape drive, an optical disk drive, etc. Removable storage drive 214 reads from and/or writes to a removable storage unit 218 in a well-known manner. Removable storage unit 218 represents a floppy disk, magnetic tape, optical disk, etc., which is read by and written to by removable storage drive 214. As will be appreciated, removable storage unit 618 includes a computer usable storage medium having stored therein computer software and/or data.

In alternative implementations, secondary memory 210 may include other similar means for allowing computer programs or other instructions to be loaded into computer system 200. Such means may include, for example, a removable storage unit 222 and an interface 220. Examples of such means may include a program cartridge and cartridge interface (such as that previously found in video game devices), a removable memory chip (such as an EPROM, or PROM, or flash memory) and associated socket, and other removable storage units 222 and interfaces 220 which allow software and data to be transferred from removable storage unit 222 to computer system 200. Alternatively, the program may be executed and/or the data accessed from the removable storage unit 222, using the processor 204 of the computer system 200.

Computer system 200 may also include a communication interface 224. Communication interface 224 allows software and data to be transferred between computer system 200 and external devices. Examples of communication interface 224 may include a modem, a network interface (such as an Ethernet card), a communication port, a Personal Computer Memory Card International Association (PCMCIA) slot and card, etc. Software and data transferred via communication interface 224 are in the form of signals 228, which may be electronic, electromagnetic, optical, or other signals capable of being received by communication interface 224. These signals 228 are provided to communication interface 224 via a communication path 226. Communication path 226 carries signals 228 and may be implemented using wire or cable, fibre optics, a phone line, a wireless link, a cellular phone link, a radio frequency link, or any other suitable communication channel. For instance, communication path 226 may be implemented using a combination of channels.

The terms “computer program medium” and “computer usable medium” are used generally to refer to media such as removable storage drive 214, a hard disk installed in hard disk drive 212, and signals 228. These computer program products are means for providing software to computer system 200. However, these terms may also include signals (such as electrical, optical or electromagnetic signals) that embody the computer program disclosed herein.

Computer programs (also called computer control logic) are stored in main memory 208 and/or secondary memory 210. Computer programs may also be received via communication interface 224. Such computer programs, when executed, enable computer system 200 to implement embodiments of the present invention as discussed herein. Accordingly, such computer programs represent controllers of computer system 200. Where the embodiment is implemented using software, the software may be stored in a computer program product and loaded into computer system 200 using removable storage drive 214, hard disk drive 212, or communication interface 224, to provide some examples.

Alternative embodiments may be implemented as control logic in hardware, firmware, or software or any combination thereof.

APPENDIX
Sample Code
Copyright Oxford Learning Solutions Ltd. 2015-16

<?php
// open the data file which lists the relative frequency/likelihood of different letter-sound
combinations
$data_file = fopen(“sounddata.json”,“r”);
$data_string = “”;
while(!feof($data_file)) {

$data_string .= fgets($data_file);

}
$data_array = json_decode($data_string, True);
// declare an array of words for testing
$input_data = Array(

Array(‘test’, “t e1 s t”),
Array(‘speaker’, “s p e2 k e3”),
Array(‘eight’, “a2 t”),
Array(‘freight’, “f r a2 t”),
Array(‘rhythm’, “r i1 th m”),
Array(‘nation’, “n a2 sh u3 n”),
Array(‘pseudonym’, “s u2 d u1 ni1 m”)

);
// run each test word through the algorithm in turn
for($i = 0; $i < count($input_data); $i ++) {

// display results for each test word
echo match_sounds_with_letters($input_data[$i][0], explode(“ ”, $input_data[$i][1]),

$data_array);

echo “<br>”;

}
function match_sounds_with_letters($word, $sounds, &$data_array) {

// generate a list of all the possible ways in which the letters and sounds could be matched
$layouts = generate_possible_layouts($word, count($sounds));
// set up array to rank the different layouts
$layout_rankings = array( );
// cycle through the possible layouts
for($i = 0; $i < count($layouts); $i ++) {

// calculate score for the given layout
$this_score = score_layout($layouts[$i], $sounds, $data_array);
// set up layout ranking object
$layout_rankings[$i] = array(

“layout” => $layouts[$i],
“score” => $this_score

);

}
// sort the layouts according to their score (best/lowest score first)
usort($layout_rankings, “sort_by_score”);
// set a threshold score above the best score, below which a layout's score is still viable
$best_score = $layout_rankings[0][“score”];
$maximum_viable_score = $best_score + 0.5 * count($sounds); // the coefficient can be

adjusted to give better results

$return_string = “”;
for($i = 0; $i < count($layout_rankings) && $i < 3 && $layout_rankings[$i][“score”] <

$maximum_viable_score; $i ++) {

for($j = 0; $j < count($layout_rankings[$i][“layout”]); $j ++) {

$return_string .= ($layout_rankings[$i][“layout”][$j] . “(“ . $sounds[$j] . ”)

”);

}
// flag viable alternative layouts
if($i > 0) $return_string .= “(viable alternative) ”;
$return_string .= “<br>”;

}
return $return_string;

}
function sort_by_score($a, $b) {

return $a[“score”] > $b[“score”];

}
function generate_possible_layouts($word, $num_sounds) {

$num_letters = strlen($word);
// determine how many more letters than sounds there are
$num_extra_letters = $num_letters − $num_sounds;
// create array to hold potential layouts
$interim_layouts = Array( );
$interim_layouts[0] = Array(array_fill(0, $num_sounds, 1));
$extra_letter_count = 0;
while($extra_letter_count < $num_extra_letters) {

// create array to hold next set of interim layouts
$interim_layouts[$extra_letter_count + 1] = Array( );
for($i = 0; $i < count($interim_layouts[$extra_letter_count]); $i ++) {

for($j = 0; $j < $num_sounds; $j ++) {

$copied_array = $interim_layouts[$extra_letter_count][$i];
$copied_array[$j] += 1;
array_push($interim_layouts[$extra_letter_count + 1],

$copied_array);

}

}
$extra_letter_count ++;

}
$numeric_layouts = array_values(array_unique($interim_layouts[$num_extra_letters],

SORT_REGULAR));

$letter_layouts = Array( );
for($i = 0; $i < count($numeric_layouts); $i ++) {

$letter_tally = 0;
$letter_layouts[$i] = Array( );
for($j = 0; $j < $num_sounds; $j ++) {

$letter_layouts[$i][$j] = substr($word, $letter_tally,

$numeric_layouts[$i][$j]);

$letter_tally += $numeric_layouts[$i][$j];

}

}
return $letter_layouts;

}
// a function which returns the total score for a given mapping/layout of sounds to letters
function score_layout($layout, $sounds, &$data_array) {

$score_tally = 0;
// find the score for each letter-sound combination in the layout and add it to the tally
for($i = 0; $i < count($layout); $i ++) {

$score_tally += score_combination($layout[$i], $sounds[$i], $data_array);

}
return $score_tally;

}
// a function which returns a score for a given letter-sound combination
// a lower score is given for combinations which are likely to occur in English words
function score_combination($letters, $sound, &$data_array) {

$combination_type = get_combination_type($letters, $sound);
if(array_key_exists($sound, $data_array) && array_key_exists($letters,

$data_array[$sound])) {

// if the given letter-sound combination is defined, return a score (lower for

common combinations, higher for rare combinations)

return 3 * (1 − $data_array[$sound][$letters]);

} else if($combination_type == “vowel sound vowel letters”) {

// if the combination is not defined, a score is instead assigned based on how well

the type of sound matches the type of letter(s)

return 5;

} else if($combination_type == “consonant sound consonant letters”) {

return 6;

} else if($combination_type == “consonant sound mixed letters”) {

return 7;

} else if($combination_type == “vowel sound mixed letters”) {

return 10;

} else if($combination_type == “vowel sound consonant letters”) {

return 15;

} else if($combination_type == “consonant sound vowel letters”) {

return 25;

}

}
// this function determines the category of a letter-sound combination
function get_combination_type($letters, $sound) {

// declare an array of vowel letters
$vowels = Array(“a”, “e”, “i”, “o”, “u”);
$sound_is_vowel = in_array(substr($sound, 0, 1), $vowels);
$letters_contain_vowel = FALSE;
$letters_contain_consonant = FALSE;
for($i=0;$i<strlen($letters);$i++) {

if(in_array(substr($letters, $i, 1), $vowels)) {

$letters_contain_vowel = TRUE;

} else {

$letters_contain_consonant = TRUE;

}

}
if($sound_is_vowel) {

if(!$letters_contain_consonant) {

return “vowel sound vowel letters”;

} else if($letters_contain_vowel) {

return “vowel sound mixed letters”;

} else {

return “vowel sound consonant letters”;

}

} else {

if(!$letters_contain_vowel) {

return “consonant sound consonant letters”;

} else if($letters_contain_consonant) {

return “consonant sound mixed letters”;

} else {

return “consonant sound vowel letters”;

}

}

}
?>

1. A computer-implemented method of determining a sequence of graphemes in a given word corresponding to a given sequence of phonemes corresponding to the given word, the method comprising:
accessing a database of potential matches between phonemes and graphemes,
identifying, by means of the database, one or more possible sequences of graphemes in the given word, each corresponding to the given sequence of phonemes; and
outputting data representing at least one said possible sequences of graphemes.

2. The method of claim 1, wherein the possible sequences of graphemes are identified by comparing each of the given sequence of phonemes with one or more letters of the given word, so as to identify a corresponding grapheme within the one or more letters.

3. The method of claim 2, wherein for each possible sequence of graphemes, each of the given sequence of phonemes is compared in turn with one or more letters of the given word to identify a corresponding grapheme, such that the corresponding grapheme is no longer considered for comparison with subsequent ones of the sequence of phonemes.

4. The method of claim 2, wherein the corresponding grapheme is identified from the database.

5. The method of claim 2, wherein if the corresponding grapheme cannot be identified from the database, a probability indication is determined for a match between the candidate phoneme and the or each possible grapheme, based on a comparison between a type of the phoneme and a type of the corresponding grapheme.

6. The method of claim 5, wherein the candidate phoneme is identified as a vowel type if it contains at least one vowel, and is otherwise identified as a consonant type phoneme.

7. The method of claim 5, wherein the possible grapheme is identified as a vowel type, a consonant type, or a mixed type containing a mixture of vowel and consonant letters.

8. The method of claim 1, wherein the database references a probability indication for each of the potential matches.

9. The method of claim 8, wherein when a plurality of possible sequences of graphemes are identified in the given word, at least one of the possible sequences of graphemes are selected for output based on the probability indications for matches between phonemes and graphemes in each of the possible sequences.

10. The method of claim 9, wherein an overall probability indication is determined for each of the possible sequences of graphemes, based on the probability indications for individual matches between phonemes and graphemes in that possible sequence.

11. The method of claim 10, including determining a threshold probability indication and selecting for output ones of the possible sequences based on a comparison between the corresponding overall probability indication and the threshold probability indication.

12. The method of claim 10, wherein data representing a plurality of said possible sequences of graphemes are output, ranked in order of the corresponding overall probability indication.

13. A computer system arranged to perform the method of claim 1.

14. A computer program product comprising program code arranged to perform the method of claim 1.
